(19) United States
(12) Patent Application Publication
(10) Pub. No.: US 2022/0321696 A1
(43) Pub. Date: Oct. 6, 2022

(54) PRESENCE BASED PRESENTATION OF CALL IDENTIFICATION INFORMATION

(71) Applicant: Avaya Management L.P., Durham, NC (US)

(72) Inventors: Shahana Mogal, Pune (IN); Isha Renavikar, Pune (IN); Ananda H P, Pune (IN)

(21) Appl. No.: 17/219,291

(22) Filed: Mar. 31, 2021

(51) Int. Cl. H04M 3/42

(52) U.S. Cl. CPC H04M 3/42034; H04M 2203/551; H04M 2203/25

(57) ABSTRACT

The technology disclosed herein enables presentation of call identification information based on user presence. In a particular embodiment, a method includes receiving a communication request directed to an endpoint of a user and determining a presence status of the user from a presence system. In response to determining that the presence status indicates the user is not present, the method includes transferring the communication request to the endpoint and preventing the endpoint from presenting call identification information associated with the communication request.

### TECHNICAL BACKGROUND

Modern communication systems and devices are capable of presenting information descriptive of an incoming communication request. For example, phone may include a display that, while the phone is ringing to notify a user of an incoming call, displays the phone number, and possibly even a name, associated with that incoming call. The call identification information is presented regardless of whether the user is even present at the endpoint receiving the incoming communication request. As such, if a person other than the endpoint's user is near the endpoint, that person will still be presented with call information even though the user may prefer it to be kept private.

### SUMMARY

The technology disclosed herein enables presentation of call identification information based on user presence. In a particular embodiment, a method includes receiving a communication request directed to an endpoint of a user and determining a presence status of the user from a presence system. In response to determining that the presence status indicates the user is not present, the method includes transferring the communication request to the endpoint and preventing the endpoint from presenting call identification information associated with the communication request.

In some embodiments, preventing the endpoint from presenting the call identification information comprises including a privacy header in the communication request, wherein the privacy header instructs the endpoint to not present the call identification information.

In some embodiments, preventing the endpoint from presenting the call identification information comprises removing the call identification information from the communication request before transferring the communication request to the endpoint.

In some embodiments, during user notification of the communication request at the endpoint, the method includes determining a subsequent presence status of the user and, upon determining that the subsequent presence status indicates the user is present, directing the endpoint to present the call identification information.

In some embodiments, the call identification information includes one or more of an identity of a calling party and a telephone number of the calling party.

In some embodiments, the method includes storing the call identification information in an entry for the communication request in a call log. The method further includes receiving a log request for the entry from the endpoint, determining a subsequent presence status of the user, and, upon determining that the subsequent presence status indicates the user is present, transferring the entry to the endpoint in response to the log request.

In some embodiments, the method includes receiving another communication request to the endpoint and determining a subsequent presence status of the user. In response to determining that the subsequent presence status indicates the user is present, the method includes transferring the other communication request to the endpoint and allowing the endpoint to present call identification information associated with the other communication request.

In some embodiments, determining the presence status comprises querying the presence system for the presence status in response to receiving the communication request.

In some embodiments, the method includes receiving an instruction from the endpoint to prevent the call information from being presented when the presence status indicates the user is not present.

In some embodiments, the endpoint presents a default message instead of the call identification information when notifying of the communication request.

In another embodiment, an apparatus is provided having one or more computer readable storage media and a processing system operatively coupled with the one or more computer readable storage media. Program instructions stored on the one or more computer readable storage media, when read and executed by the processing system, direct the processing system to receive a communication request directed to an endpoint of a user and determine a presence status of the user from a presence system. In response to determining that the presence status indicates the user is not present, the program instructions direct the processing system to transfer the communication request to the endpoint and prevent the endpoint from presenting call identification information associated with the communication request.

### BRIEF DESCRIPTION OF THE DRAWINGS

FIG. 1 illustrates an implementation for presenting call identification information based on user presence.

FIG. 2 illustrates an operation to present call identification information based on user presence.

FIG. 3 illustrates an operational scenario for presenting call identification information based on user presence.

FIG. 4 illustrates another operational scenario for presenting call identification information based on user presence.

FIG. 5 illustrates a further operational scenario for presenting call identification information based on user presence.

FIG. 6 illustrates yet another operational scenario for presenting call identification information based on user presence.

FIG. 7 illustrates an additional operational scenario for presenting call identification information based on user presence.

FIG. 8 illustrates a computing architecture for presenting call identification information based on user presence.

### DETAILED DESCRIPTION

The examples provided herein enable a communication control system to determine whether call identification information should be presented at an endpoint based on presence information of the endpoints user. In general, when a communication request directed towards an endpoint (e.g., an audio call, a video call, text message, or some other type of communication request that is routed through a communication control system) is received in a communication control system, the communication system determines whether the presence status of an endpoint user indicates that the user is present. If the user's status is present, then the communication control system allows call identification information for the communication request to be presented at the endpoint. If the user's status is not present (sometimes simply referred to as “away”), then the communication control system prevents the endpoint from presenting the call identification information.

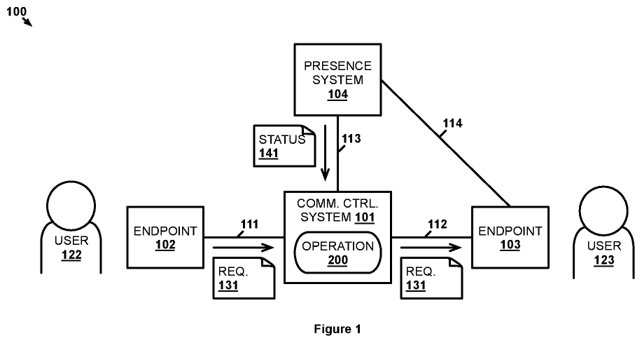

FIG. 1 illustrates implementation 100 for presenting call identification information based on user presence. Implementation 100 includes communication control system 101, endpoint 102, endpoint 103, and presence system 104. User 122 operates endpoint 102 and user 123 operates endpoint 103. Endpoint 102 and communication control system 101 communicate over communication link 111. Endpoint 103 and communication control system 101 communicate over communication link 112. Communication control system 101 and presence system 104 communicate over communication link 113. Communication links 111-113 are shown as direct links but may include intervening systems, networks, and/or devices.

In operation, endpoint 102 and endpoint 103 may each respectively be a telephone, tablet computer, laptop computer, desktop computer, conference room system, or some other type of computing device capable of connecting to a communication session facilitated by communication control system 101. Communication control system 101 facilitates communication sessions between two or more endpoints, such as endpoint 102 and endpoint 103. A communication session may be audio only (e.g., a voice call) or may also include at least a video component (e.g., a video call). During a communication session, user 122 and user 123 are able to speak with, or to, one another by way of their respective endpoints 102 and 103.

Communication control system 101 performs operation 200 to determine whether call identification information should be presented at endpoint 103 for a communication directed to endpoint 103. In this example, the communication is directed to endpoint 103 via communication request 131 from endpoint 102. While endpoint 102 is operated by user 122, it is possible that, in other examples, the originator of communication request 131 may be an unmanned system, such as an automated messaging system or an Interactive Voice Response (IVR) system. Communication request 131 may be for a voice call, a video call, a text-based chat, or some other type of real time user communication session. While referred to as call identification information, the call identification information may be associated with any real time communication mode, not just calls. The call identification information may include a calling telephone number, a username of the calling party, a real name of the calling party, or some other type of identifying information associated with the calling endpoint and/or calling party—including combinations thereof. The call identification information may be included in communication request 131 when received by communication control system 101 or may be identified by communication control system 101 in some other manner.

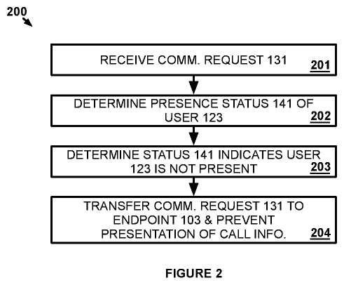

FIG. 2 illustrates operation 200 to present call identification information based on user presence. In operation 200, communication control system 101 receives communication request 131 directed to endpoint 103 of user 123 (201). Communication control system 101 further determines presence status 141 of user 123 from presence system 104 (202). Presence system 104 is a computing system that maintains presence information for users of a communication service associated with presence system 104. For example, the communication service may include an intra-office communication platform (e.g., text messaging, file sharing, etc.) to which endpoint 103 has access (e.g., endpoint 103 may execute a client for accessing the platform). The presence information includes a presence status for users associated therewith and presents the present status to other users (e.g., in a buddy list of a user group). The presence status at least indicates whether a user is present at their user system, or is away from their user system. In this case, the user system of user 123 is also endpoint 103, although, in other examples, the user system may be a different device. Presence system 104 may determine that a user is not present, or is “away”, based on the user not interacting with their user system for a threshold amount of time, based on the user not interacting with a client application for presence system 104 that is executing on the user system (e.g., a client for the communication service of presence system 104), based on the user explicitly indicating that they are away (e.g., selecting an away status in the client application), or based on some other convention for determining presences status by a presence system. In some cases, endpoint 103 may inform presence system 104 of user 123's presences status based on similar factors (e.g., user not interacting for a threshold time).

In some examples, outside of retrieving presence status information from presence system 104, the operation of communication control system 101 may be independent of presence system 104 and any communication service for which presence system 104 otherwise handles presence information. In some examples, presence system 104 may also provide at least a portion of the communications service associated therewith. In some examples, communication control system 101 may provide at least a portion of the communication service (e.g., the communication service may include the service through which communication request 131 is sent and, if answered, through which a communication session is established between endpoint 102 and endpoint 103). Although, in other examples, the communication service provided by communication control system 101 may be a separate service.

In this example, communication control system 101 determines that presence status 141 indicates that user 123 is not present (203). In response to that determination, communication control system 101 transfers communication request 131 to endpoint 103 and prevents endpoint 103 from presenting call identification information associated with communication request 131 (204). Communication control system 101 may prevent endpoint 103 from presenting the call identification information by removing any of the call identification information included in communication request 131 before transferring communication request 131 to endpoint 103, by not adding call identification information that was not already included in communication request 131, by instructing endpoint 103 to not present call identification information even though such information may be included in communication request 131, or by performing some other action that would result in endpoint 103 not presenting call identification information—including combinations thereof. In examples where call identification is removed or not included in communication request 131, communication control system 101 may replace the call identification information with call identification information that is unrelated to communication request 131 (e.g., may change a calling party name field to “anonymous caller”) or may allow endpoint 103 to decide how to handle a communication request without call identification information. In some examples, all caller identification information is prevented from being presented while, in other examples, communication control system 101 prevents endpoint 103 from presenting a subset of what endpoint 103 would otherwise have presented. For instance, if endpoint 103 would normally present a calling party name and telephone number, communication control system 101 may prevent endpoint 103 from presenting the calling party name while still allowing presentation of the telephone number.

Advantageously, communication control system 101 ensures that endpoint 103 does not present call identification information when user 123 is not present, at least not present according to presence system 104. Essentially, operation 200 allows communication control system 101 to operate under the assumption that, if presence system 104 indicates user 123 is not present, user 123 is not present at endpoint 103. In some examples, communication control system 101 may perform operation 200 by default or user 123 may instruct communication control system 101 to perform operation 200 for incoming communication requests (e.g., by enabling a setting).

While operation 200 is performed by communication control system 101 in the above example, operation 200 may be performed by endpoint 103 itself in other examples. For instance, upon receiving communication request 131 from endpoint 102, endpoint 103 may itself query presence system 104 for presence status 141, either directly or by communicating with a client application executing on endpoint 103 that synchronizes presence status 141 with presence system 104.

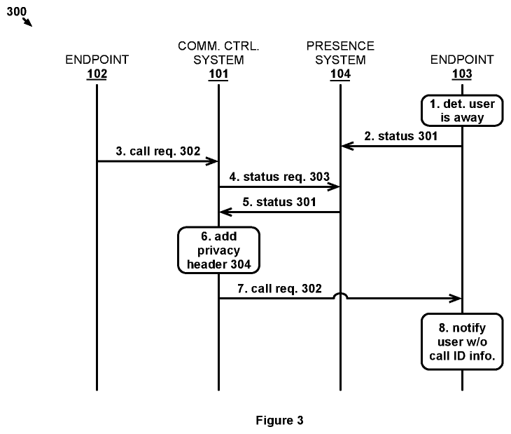

FIG. 3 illustrates operational scenario 300 for presenting call identification information based on user presence. In operational scenario 300, endpoint 103 determines that user 123 is away at step 1. To determine the user 123 is away, endpoint 103 may determine that user 123 has not interacted with endpoint 103 within a predefined threshold amount of time (e.g., within the last five minutes), that user 123 has not interacted with a client application for the communication service associated with presence system 104 for a predefined threshold amount of time, that endpoint 103 has gone to sleep (e.g., put in a standby mode), that user 123 has explicitly set their status to “away”, or that some other indication exists to indicate that user 123 is not present at endpoint 103 or otherwise wants their presence status to indicate such. Upon determining that user 123 is away, endpoint 103 sends presence status 301 to presence system 104 at step 2, which indicates to presence system 104 that user 123 is now away.

At a time after presence system 104 has been updated with presence status 301, endpoint 102 initiates call request 302 directed to endpoint 103 at step 3. Call request 302 may use a packet based communication protocol or may comprise a call request using circuit switched plain old telephone service. Call request 302 may be a request for a voice call or a video call. Upon receiving call request 302, communication control system 101 transfers status request 303 at step 4 to presence system 104 to determine the current presence status of user 123. Communication control system 101 may know that user 123 is associated with endpoint 103 based on a user (user 123 or otherwise) indicating to communication control system 101 that endpoint 103 is associated with user 123 (e.g., may include a directory that associates a phone number of endpoint 103 with user 123), endpoint 103 may identify user 123 when registering with communication control system 101, or communication control system 101 may associate endpoint 103 with user 123 in some other manner. In some examples, presence system 104 may require a username or other identifier for user 123 rather than user 123's real name. In those examples, communication control system 101 would also be provided with the username/identifier necessary to indicate user 123 in status request 303. Other manners of identifying user 123 to presence system 104 in status request 303 may also be used.

In response to status request 303, presence system 104 provides presence status 301 at step 5 to communication control system 101. Presence status 301 may be provided to communication control system 101 in the same manner presence system 104 provides presence status to user systems of other users for which presence system 104 maintains presence status (e.g., user systems of other users having user 123 in their buddy lists). However, communication control system 101 and presence system 104 may use a different convention to exchange information, such as presence status 301 and status request 303.

Upon receiving presence status 301, communication control system 101 becomes aware that user 123 is away, which indicates to communication control system 101 that call information should not be presented by endpoint 103 when call request 302 is received thereat. In this example, call request 302 is a call request defined by a packet based protocol (e.g., Session Initiation Protocol) that allows for privacy headers. Thus, to prevent endpoint 103 from presenting call identification information, communication control system 101 adds privacy header 304 to call request 302 at step 6. In this example, call request 302 may have originated in a packet-based protocol or, if not, either communication control system 101 or a system between el10 and communication control system 101 converted call request 302 to a packet-based protocol so that privacy header 304 can be added.

After adding privacy header 304, communication control system 101 transfers call request 302 to endpoint 103 at step 7. Upon receiving call request 302, endpoint 103 notifies user 123 about call request 302 without presenting call identification information at step 8 (or at least attempts to since user 123 is currently away according to presence status 301). The call identification information is not presented because endpoint 103 reads privacy header 304 from call request 302 and determines that privacy header 304 indicates caller identification information associated with call request 302 should not be presented, even if the information is present in call request 302. The existence of privacy header 304 alone may indicate that caller identification information should not be presented or there may be an instruction within privacy header 304 that, when read by endpoint 103, directs endpoint 103 to not present caller identification information. A client application may be executing on endpoint 103 to communicate with communication control system 101, or some other type of instructions may be executing on endpoint 103 (e.g., firmware), that directs endpoint 103 to not present caller identification information in response to privacy header 304. In some examples, endpoint 103 will present something else in place of caller identification information that indicates to user 123 (or other person at endpoint 103) that caller identification information is not being presented (e.g., may display “caller identification information hidden”).

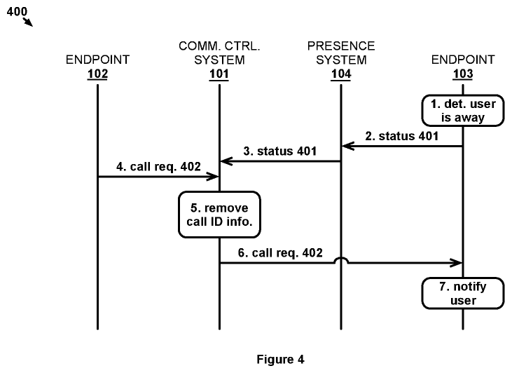

FIG. 4 illustrates operational scenario 400 for presenting call identification information based on user presence. In operational scenario 400, endpoint 103 determines that user 123 is away at step 1 and transfers presence status 401 to presence system 104 at step 2, which indicates to presence system 104 that user 123 is away. In this example, rather than waiting for a request for presence status 401 from communication control system 101, presence system 104 automatically sends presence status 401 to communication control system 101 at step 3 in response to receiving presence status 401 from endpoint 103. Communication control system 101 may, therefore, receive presence status 401 in the same manner that other user systems would be provided with presence status 401. For instance, a user system of a user having user 123 in their buddy list would be automatically pushed presence status 401 from presence system 104 so that the buddy list can present user 123 as being away in real time. Presence system 104 may, therefore, use the same processes as are used to perform the buddy list update to update communication control system 101 at step 3.

Since communication control system 101 is automatically updated with presence status 401, when call request 402 is received from endpoint 102 at step 4, communication control system 101 does not need to query presence system 104 for user 123's presence status. Instead, communication control system 101 already knows that presence status 401 indicates user 123 is away and removed caller identification information from call request 402 at step 5. Communication control system 101 may remove the caller identification information instead of using a privacy header when a privacy header is not supported by the communication protocol used for call request 402 or when additional assurance that caller identification information will not be presented is desired. Removing caller identification information may include removing any information identifying endpoint 102 and/or user 122 from within call request 402 or the packet(s) carrying call request 402, removing information (e.g., network addresses) that would allow call request 402 to be traced back to its source, and/or removing some other type of information that may allow endpoint 103 to present caller identification information.

When call request 402 is transferred from communication control system 101 to endpoint 103 at step 6, endpoint 103 simply notifies user 123 about the request at step 7 (or at least attempts to since user 123 is currently away according to presence status 401). Since the caller identification information removed by communication control system 101 is no longer in call request 402, endpoint 103 cannot present that caller identification information when notifying user 123. Thus, unlike in operational scenario 300 where endpoint 103 had to follow the direction of privacy header 304, endpoint 103 simply notifies the user as normal and presents whatever caller identification information is available, which does not include what communication control system 101 removed.

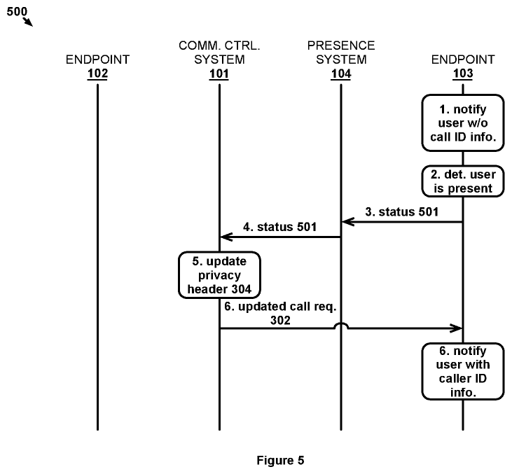

FIG. 5 illustrates operational scenario 500 for presenting call identification information based on user presence. Operational scenario 500 is a continuation of operational scenario 300 where step 1 of operational scenario 500 is the same as step 8 of operational scenario 300. In particular, at step 1, endpoint 103 is notifying, or attempting to notify, user 123 about call request 302 without presenting call identification information. While that notification is occurring, endpoint 103 determines that user 123 is now present at step 2. To determine the user 123 is present, endpoint 103 may determine that user 123 has begun interacting with endpoint 103, that user 123 has begun interacting with a client application for the communication service associated with presence system 104, that endpoint 103 has been awoken from sleep (e.g., changed to active mode from a standby mode), that user 123 has provided user credentials (e.g., username/password, fingerprint, facial recognition, etc.) to endpoint 103, that user 123 has explicitly set their status to “available”, or that some other indication exists to indicate that user 123 is now present at endpoint 103 or otherwise wants their presence status to indicate such. For example, user 123 may be nearby endpoint 103 and, in response to seeing that no caller identification information is being presented with the call notification, user 123 may interact with endpoint 103 (e.g., awaken endpoint 103 and move a mouse cursor) to cause user 123's presence status to update to indicate that user 123 is present at endpoint 103 (sometimes referred to as “available”).

Upon determining that user 123 is present, endpoint 103 transfers presence status 501 to presence system 104 at step 3 to update presence system 104 about user 123 now being present at endpoint 103. In this example, presence system 104 transfers presence status 501 at step 4 to communication control system 101 to update communication control system 101 about user 123's presence status. Even though communication control system 101 had to request presence status 301 in operational scenario 300, presence system 104 may remember that request for a predefined period of time (e.g., corresponding to a length in which endpoint 103 will typically notify about incoming call requests) so that, should user 123's presence status be updated within that time, presence system 104 will inform communication control system 101 about that update, as is the case in the present example. Alternatively, communication control system 101 may request updates to the presence status until endpoint 103 is no longer notifying about call request 302 (e.g., until call request 302 times out, is declined, is canceled from endpoint 102, or is answered at endpoint 103).

Upon communication control system 101 receiving presence status 501, communication control system 101 updates privacy header 304 in call request 302 at step 5 to indicate that caller identification information can be presented by endpoint 103. In some cases, privacy header 304 may be removed altogether or the instruction therein may be changed. Communication control system 101 then sends the version of call request 302 with the updated privacy header 304 to endpoint 103 at step 6. In response to receiving the updated version of call request 302, endpoint 103 begins presenting caller identification information, in accordance with privacy header 304, while continuing to notify user 123 about call request 302 at step 6. For example, at step 1, endpoint 103 may be presenting “caller identification information unavailable” and then begin presenting “User 122 calling from endpoint 102” upon operational scenario 500 reaching step 6. Alternative manners of instructing endpoint 103 to begin presenting caller identification information for call request 302 may also be used. For instance, since the caller identification information is removed from call request 402 in operational scenario 400, communication control system 101 may transfer the removed caller identification information to endpoint 103 and endpoint 103 simply begins presenting that caller identification information upon receipt.

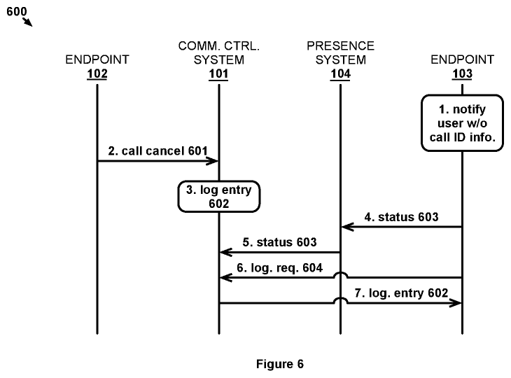

FIG. 6 illustrates operational scenario 600 for presenting call identification information based on user presence. Operational scenario 600 begins similar to how operational scenario 300 ended with endpoint 103 notifying, or attempting to notify, user 123 at step 1 about call request 302 without presenting call identification information. Although, step 1 could also be analogous to step 7 of operational scenario 400 where the user notification occurs without presenting caller identification information due to the caller identification information being absent from call request 402. Regardless, during the user notification, communication control system 101 receives call cancellation 601 at step 2 from endpoint 102. Call cancellation 601 may be triggered by user 122 hanging up a handset of endpoint 102, user 122 pressing an end call button, or by some other manner of endpoint 102 determining that call cancellation 601 should be sent. Call cancellation 601 may be a broken circuit if a circuit switched communication with communication control system 101, may be a cancellation control message in a packet-based protocol used for communications between endpoint 102 and communication control system 101, or may be some other type of signaling for notifying communication control system 101 that the call is being canceled by endpoint 102. In other examples, the call may be canceled by endpoint 103 denying the call (e.g., in response to user input at endpoint 103), by the call timing out without an answer at endpoint 103, by the call being sent to voicemail, or for some other reason.

Even though caller identification information was not presented by endpoint 103, communication control system 101 still creates log entry 602 for call request 302, which includes the caller identification information, at step 3 and stores log entry 602 in a call log for endpoint 103. Log entry 602 may also include a time in which call request 302 occurred, an outcome of call request 302 (e.g., missed in this case but may be answered, outgoing, etc. for others), or some other information relevant to call request 302. The call log also contains entries for other incoming/outgoing call requests with endpoint 103.

At a time after log entry 602 is created, endpoint 103 determines that user 123 is now present and endpoint 103 transfers presence status 603 to presence system 104 at step 4 to update presence system 104 about user 123 now being present at endpoint 103. In this example, presence system 104 then transfers presence status 603 at step 5 to communication control system 101 to update communication control system 101 about user 123's presence status. When communication control system 101 then receives a log request 604 at step 6, communication control system 101 responsively transfers log entry 602 to endpoint 103 since presence status 603 indicates that user 123 is present at endpoint 103. While presence status 603 is pushed to communication control system 101 automatically in this example, communication control system 101 may instead request presence status 603 from presence system 104 upon receiving log request 604.

In other examples, if the presence status of user 123 indicated that user 123 is not present when log request 604 is received, then communication control system 101 may have declined to provide log entry 602 or may have provided log entry 602 without the caller identification information associated with log entry 602 (e.g., may simply indicate that a call was missed but not provide caller identification information indicating that the call was from endpoint 102). Thus, if user 123 is not present according to their presence status in presence system 104, endpoint 103 will still not provide caller identification information even to a user at endpoint 103 attempting to view call logs.

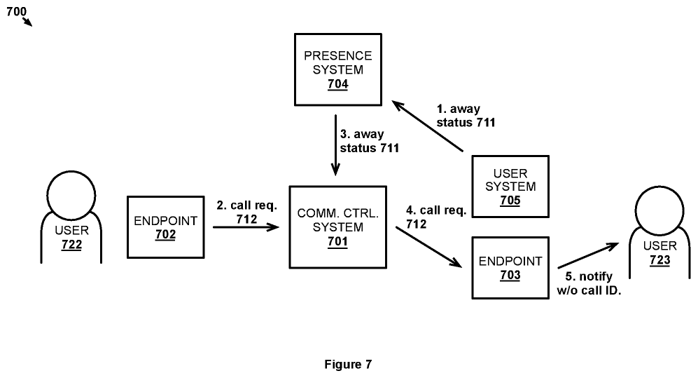

FIG. 7 illustrates operational scenario 700 for presenting call identification information based on user presence. Operational scenario 700 involves communications control system 701, endpoint 702, endpoint 703, presence system 704, and user system 705. Systems 701-704 are similar to systems 101-104 in implementation 100. User system 705 is a user operable computing system (e.g., desktop computer, laptop computer, tablet computer, smartphone, etc.) that is separate from endpoint 703 while also being associated with user 723. For example, user system 705 may be a computer workstation operated by user 723 while endpoint 703 may be a desk telephone of user 723. Endpoint 703 and user system 705 may be physically located next to one another so that user 723's presence status on user system 705 is more likely to also represent whether user 723 is present at endpoint 703.

In the above examples, user 123's presence status is determined from the same system (i.e., endpoint 103) to which the incoming call request is directed. Operational scenario 700 is an example where the presence status of user 723 is determined from a different system than that to which an incoming call request is directed. For example, while endpoint 103 executed a client application associated with a communication service of presence system 104 in addition to being able to exchange communications with communication control system 101, user system 705 of operational scenario 700 executes the client application while endpoint 703 exchanges communications with communication control system 101.

In operational scenario 700, user system 705 determines that user 723 is away and notifies presence system 704 with away status 711 at step 1. User system 705 may determine that user 723 is away based on user 723 not interacting with user system 705 for a threshold amount of time, based on user 723 not interacting with a client application for presence system 704 that is executing on user system 705, based on user 723 explicitly indicating that they are away, or based on some other convention for determining presences status. When communications control system 701 receives call request 712 from endpoint 702 at step 2 for user 722 to speak with user 723, communications control system 701 also receives away status 711 at step 3 from presence system 704. In some examples, communications control system 701 may query presence system 704 for user 723's status in response to receiving call request 712 while, in other examples, presence system 704 may push away status 711 to communications control system 701 automatically (e.g., in response to receiving away status 711 from user system 705).

Since away status 711 indicates user 723 is away, communications control system 701 transfers call request 712 to endpoint 703 at step 4 in a manner that prevents endpoint 703 from presenting caller identification information when notifying user 723 about call request 712 (or at least attempting to notify user 723 since user 723's status is away). For instance, as discussed in the examples above, communications control system 701 may remove the caller identification information from call request 712 before sending call request 712 to endpoint 703 or may use a privacy header to instruct endpoint 703 to not present caller identification information that is still included in call request 712. Regardless, endpoint 703 does not present the caller identification information associated with call request 712 based on the presence status of user 723 determined by another system (i.e., user system 705).

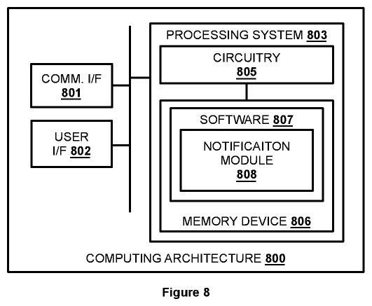

FIG. 8 illustrates computing architecture 800 for presenting call identification information based on user presence. Computing architecture 800 is an example computing architecture for communication control system 101 and endpoint 103, although systems 101 and 103 may use alternative configurations. Computing architecture 800 may also be used for other computing systems discussed herein, although those systems may also use alternative configurations. Computing architecture 800 comprises communication interface 801, user interface 802, and processing system 803. Processing system 803 is linked to communication interface 801 and user interface 802. Processing system 803 includes processing circuitry 805 and memory device 806 that stores operating software 807.

Communication interface 801 comprises components that communicate over communication links, such as network cards, ports, RF transceivers, processing circuitry and software, or some other communication devices. Communication interface 801 may be configured to communicate over metallic, wireless, or optical links. Communication interface 801 may be configured to use TDM, IP, Ethernet, optical networking, wireless protocols, communication signaling, or some other communication format—including combinations thereof.

User interface 802 comprises components that interact with a user. User interface 802 may include a keyboard, display screen, mouse, touch pad, or some other user input/output apparatus. User interface 802 may be omitted in some examples.

Processing circuitry 805 comprises microprocessor and other circuitry that retrieves and executes operating software 807 from memory device 806. Memory device 806 comprises a computer readable storage medium, such as a disk drive, flash drive, data storage circuitry, or some other memory apparatus. In no examples would a storage medium of memory device 806 be considered a propagated signal. Operating software 807 comprises computer programs, firmware, or some other form of machine-readable processing instructions. Operating software 807 includes notification module 808. Operating software 807 may further include an operating system, utilities, drivers, network interfaces, applications, or some other type of software. When executed by processing circuitry 805, operating software 807 directs processing system 803 to operate computing architecture 800 as described herein.

In particular, notification module 808 directs processing system 803 to receive a communication request directed to an endpoint of a user and determine a presence status of the user from a presence system. In response to determining that the presence status indicates the user is not present, notification module 808 directs processing system 803 to transfer the communication request to the endpoint and prevent the endpoint from presenting call identification information associated with the communication request.

The descriptions and figures included herein depict specific implementations of the claimed invention(s). For the purpose of teaching inventive principles, some conventional aspects have been simplified or omitted. In addition, some variations from these implementations may be appreciated that fall within the scope of the invention. It may also be appreciated that the features described above can be combined in various ways to form multiple implementations. As a result, the invention is not limited to the specific implementations described above, but only by the claims and their equivalents.

What is claimed is:

1. A method comprising:
receiving a communication request directed to an endpoint of a user;
determining a presence status of the user from a presence system;
in response to determining that the presence status indicates the user is not present:
transferring the communication request to the endpoint; and
preventing the endpoint from presenting call identification information associated with the communication request.

2. The method of claim 1, wherein preventing the endpoint from presenting the call identification information comprises:
including a privacy header in the communication request, wherein the privacy header instructs the endpoint to not present the call identification information.

3. The method of claim 1, wherein preventing the endpoint from presenting the call identification information comprises:
removing the call identification information from the communication request before transferring the communication request to the endpoint.

4. The method of claim 1, comprising:
during user notification of the communication request at the endpoint, determining a subsequent presence status of the user; and
upon determining that the subsequent presence status indicates the user is present, directing the endpoint to present the call identification information.

5. The method of claim 1, wherein the call identification information includes one or more of an identity of a calling party and a telephone number of the calling party.

6. The method of claim 1, comprising:
storing the call identification information in an entry for the communication request in a call log;
receiving a log request for the entry from the endpoint;
determining a subsequent presence status of the user; and
upon determining that the subsequent presence status indicates the user is present, transferring the entry to the endpoint in response to the log request.

7. The method of claim 1, comprising:
receiving another communication request to the endpoint
determining a subsequent presence status of the user;
in response to determining that the subsequent presence status indicates the user is present:
transferring the other communication request to the endpoint; and
allowing the endpoint to present call identification information associated with the other communication request.

8. The method of claim 1, wherein determining the presence status comprises:
querying the presence system for the presence status in response to receiving the communication request.

9. The method of claim 1, comprising:
receiving an instruction from the endpoint to prevent the call information from being presented when the presence status indicates the user is not present.

10. The method of claim 1, wherein the endpoint presents a default message instead of the call identification information when notifying of the communication request.

11. An apparatus comprising:
one or more computer readable storage media;
a processing system operatively coupled with the one or more computer readable storage media; and
program instructions stored on the one or more computer readable storage media that, when read and executed by the processing system, direct the processing system to:
receive a communication request directed to an endpoint of a user;
determine a presence status of the user from a presence system;
in response to determining that the presence status indicates the user is not present:
transfer the communication request to the endpoint; and
prevent the endpoint from presenting call identification information associated with the communication request.

12. The apparatus of claim 11, wherein to prevent the endpoint from presenting the call identification information, the program instructions direct the processing system to:
include a privacy header in the communication request, wherein the privacy header instructs the endpoint to not present the call identification information.

13. The apparatus of claim 11, wherein to prevent the endpoint from presenting the call identification information, the program instructions direct the processing system to:
remove the call identification information from the communication request before transferring the communication request to the endpoint.

14. The apparatus of claim 11, wherein the program instructions direct the processing system to:
during user notification of the communication request at the endpoint, determine a subsequent presence status of the user; and
upon determining that the subsequent presence status indicates the user is present, direct the endpoint to present the call identification information.

15. The apparatus of claim 11, wherein the call identification information includes one or more of an identity of a calling party and a telephone number of the calling party.

16. The apparatus of claim 11, wherein the program instructions direct the processing system to:
store the call identification information in an entry for the communication request in a call log;
receive a log request for the entry from the endpoint;
determine a subsequent presence status of the user; and
upon determining that the subsequent presence status indicates the user is present, transfer the entry to the endpoint in response to the log request.

17. The apparatus of claim 11, wherein the program instructions direct the processing system to:
receive another communication request to the endpoint
determine a subsequent presence status of the user;
in response to determining that the subsequent presence status indicates the user is present:
transfer the other communication request to the endpoint; and
allow the endpoint to present call identification information associated with the other communication request.

18. The apparatus of claim 11, wherein to determine the presence status, the program instructions direct the processing system to:
query the presence system for the presence status in response to receiving the communication request.

19. The apparatus of claim 11, wherein the program instructions direct the processing system to:
receive an instruction from the endpoint to prevent the call information from being presented when the presence status indicates the user is not present.

20. One or more computer readable storage media having program instructions stored on the one or more computer readable storage media that, when read and executed by a processing system, direct the processing system to:
receive a communication request directed to an endpoint of a user;
determine a presence status of the user from a presence system;
in response to determining that the presence status indicates the user is not present:
transfer the communication request to the endpoint; and
prevent the endpoint from presenting call identification information associated with the communication request.
